(19) United States
(12) Patent Application Publication
(10) Pub. No.: US 2012/0023552 A1
(43) Pub. Date: Jan. 26, 2012

(54) METHOD FOR DETECTION OF A ROGUE WIRELESS ACCESS POINT

(76) Inventor: Jeremy Brown, Roseville, CA (US)

(21) Appl. No.: 13/260,153

(22) PCT Filed: Jul. 31, 2009
(86) PCT No.: PCT/US2009/052502

§ 371 Date: Sep. 23, 2011

(51) Int. Cl. G06F 21/20; G06F 15/173

(52) U.S. Cl. 726/3; 709/225

(57) ABSTRACT

A method for processing a packet is described herein. The packet is received by a network device of a wired network. The packet is filtered if a field in the packet matches a marker designated for indicating a path of the packet includes a rogue access point (AP). Upon filtering, a location on the wired network is determined. The location connects the wired network to a rogue AP from which the packet was received.

### I. BACKGROUND

The Institute of Electrical and Electronics Engineers (“IEEE”) established the wireless local area network (“WLAN”) standard, in the IEEE 802.11 Working Group. The standard has generated various activities related to the development and implementation of small scale wireless networks and discussions of large scale wireless networks. The convenience afforded to computer users, especially those with portable computers, to be connected to a network without a physical, wired connection is just one of the factors driving the popularity of wireless network communications. Wireless networking can be easily added to an existing, wired network. For example, simply connecting a wireless access point (AP) to a switch port, allows wireless devices to access the network, such as a wide area network (WAN) or a local area network (LAN).

Wireless networks pose security risks not generally encountered in wired networks. By default, wireless APs typically do not have security features enabled. Without security barriers at the wireless AP, it is simple for a wireless client to gain access to the network. An unauthorized (i.e., rogue) wireless AP may be connected to the network, exposing the wired network to unauthorized access by any wireless client in the coverage area and possibly affecting the performance of the wired and wireless networks. Thus, it is therefore relatively easy for a network to be compromised via a wireless connection.

To minimize the risk to the wired network, it is desirable to locate and disable the rogue AP. Often times, finding the rogue AP may be a difficult task.

### II. BRIEF DESCRIPTION OF THE DRAWINGS

FIG. 1 is topological block diagram of a network system in accordance with an embodiment of the invention.

FIG. 2 is another topological block diagram of a network system in accordance with an embodiment of the invention.

FIG. 3 is a process flow diagram for sending a marked network communication in accordance with an embodiment of the invention.

FIG. 4 is a process flow diagram for detecting a rogue wireless access point in accordance with an embodiment of the invention.

FIG. 5 is a block diagram of an exemplary packet switch in accordance with an embodiment of the invention.

### III. DETAILED DESCRIPTION OF THE INVENTION

Rogue wireless access points (APs) may expose wireless networks and wired networks coupled thereto to unauthorized access. A rogue AP may be identified, detected, and quarantined from the wired networks. One or more unsecured wireless networks may be determined, for example, by a controlled node of the wireless network. A wireless access point (AP) associated with the unsecured wireless network may be identified as a rogue AP. A connection to the unsecured wireless network is established through the rogue AP. A packet including a marker designated for indicating a path of the packet includes the rogue AP may be generated and transmitted to the rogue AP.

The packet is received by an edge network device of a wired network. The packet is filtered if a field in the packet matches a network address marker designated for indicating that a path of the packet includes a rogue access point (AP). Upon filtering, a location on the wired network is determined. The location connects the wired network to a rogue AP from which the packet was received. An address of the rogue AP may also be determined. The rogue AP may be quarantined from the wired network.

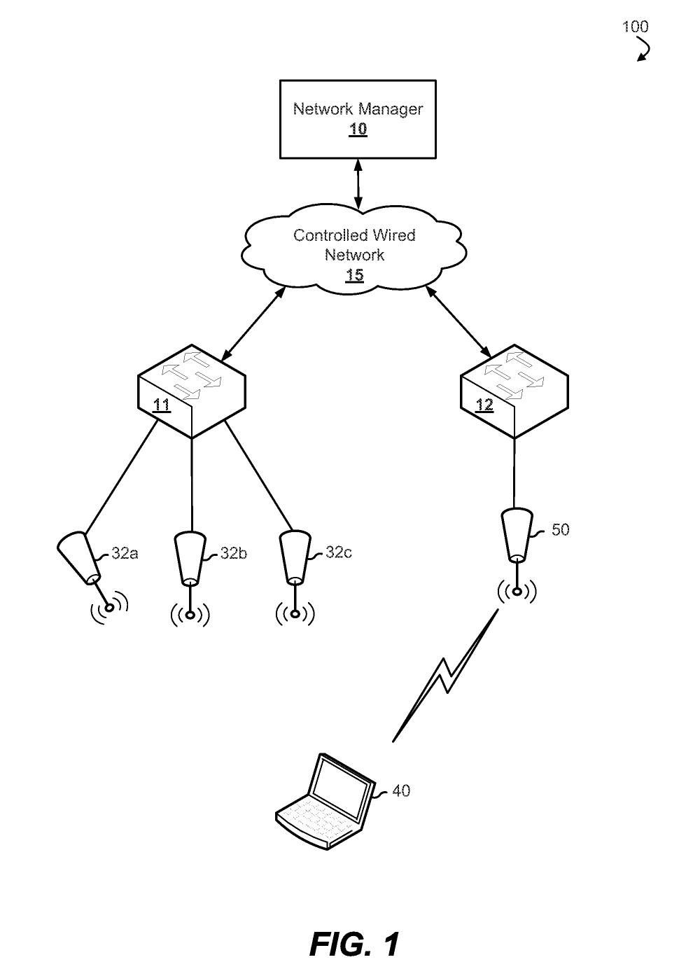

FIG. 1 is topological block diagram of a network system 100 in accordance with an embodiment of the invention. System 100 includes a network manager 10, a controlled wired network 15, a network switch 11, a network switch 12, wireless access points 32a, 32b, 32c, (collectively referred to as wireless access points 32), rogue wireless access point (rogue AP) 50, and controlled wireless client 40.

Network manager 10 is configured to plan, deploy, manage, and/or monitor a network such as a wireless local area network (WLAN). Network manager 10 is operatively coupled to network switch 11 and network switch 12 via controlled wired network 15. The connection between network manager 10 and network switches 11 and 12 may include multiple network segments, transmission technologies and components.

Network switch 11 is operatively coupled to network manager 10 via controlled wired network 15. Network switch 11 includes multiple ports to which wireless access points 32 are connected. In one embodiment, wireless access points 32 are arranged in a physical location that is central to wireless clients. Network switch 11 is an edge device. As used herein, an edge device is a network switch, router, or other network device on the edge of a wired network. Client devices connect directly to the edge device via an edge port. As used herein, an edge port is a client-connected port of an edge device.

Network switch 12 is operatively coupled to network manager 10 via controlled wired network 15. Network switch 12 includes multiple ports, at least one of which connects to rogue AP 50. Network switch 12 is also an edge device.

In one embodiment, network switch 11 and/or network switch 12 is configured to receive a marked network communication from a controlled device (i.e., a controlled wireless client or a controlled wireless AP), detect a rogue AP using the marked network communication, and quarantine the rogue AP from controlled wired network 15. Network switch 11 and/or network switch 12 may be further configured to log the detection of the rogue AP.

Wireless access points 32 are operatively coupled to network switch 11. Wireless access points 32 are configured to connect a wireless client to a wireless network. One or more of wireless access points 32 are controlled access points (controlled APs). As used herein, a controlled access point is a wireless AP which is part of a controlled wired network which is compromised by a rogue AP.

Controlled wireless client (CWC) 40 is communicatively coupled to rogue AP 50. As used herein, a controlled wireless client, such as CWC 40, is a wireless client which is managed by a same security policy enforced on a controlled wired network and controlled APs. For example, in the corporate context, a CWC may include a company-owned notebook computer. In one embodiment, CWC 40 is configured to determine an unsecured wireless network, identify a wireless AP associated with the unsecured network as a rogue AP, connect to the unsecured wireless network via the rogue AP, and send a marked network communication through the connection.

Rogue AP 50 is operatively coupled to controlled wired network 15 via network switch 12. As used herein, a rogue AP, such as rogue AP 50, is an access point that is connected to a controlled wired network and which compromises the security of the controlled wired network.

The present invention can also be applied in other network topologies and environments. Network 100 may be any type of network familiar to those skilled in the art that can support date communications using any of a variety of commercially-available protocols, including without limitation TCP/IP, SNA, IPX, AppleTalk, and the like. Merely by way of example, network 100 can be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth protocol known in the art, and/or any other wireless protocol); and/or any combination of these and/or other networks.

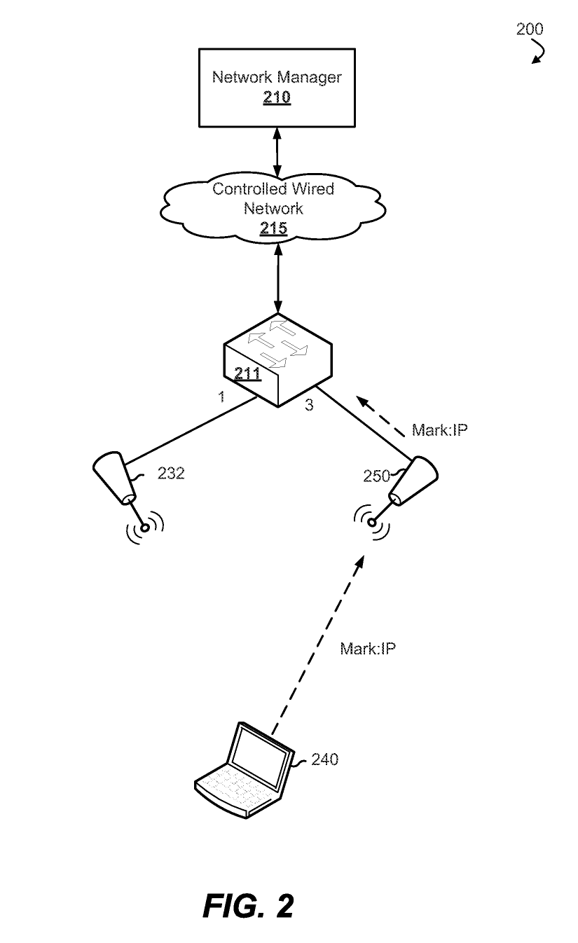

FIG. 2 is another topological block diagram of a network system 200 in accordance with an embodiment of the invention. Network system 200 includes a network manager 210, a controlled wired network 215, network switch 211, controlled wireless access point 232, rogue wireless access point 250, and controlled wireless client 240. Controlled wireless access point (Controlled AP) 232 is operatively coupled to port 1 of network switch 211. Rogue wireless access point (rogue AP) 250 is operatively coupled to port 3 of network switch 211.

In operation, controlled wireless client (CWC) 240 identifies rogue AP 250 as being a rogue AP, i.e., a wireless AP that is connected to a controlled wired network and which compromises the security of the wired network. For example, CWC 240 may perform a scan of the surrounding area and may discover an unsecured wireless network which is not a part of a managed network, i.e., not within the purview and control of network manager 210. After further processing, the access point associated with the unsecured wireless network is deemed to be a rogue AP, such as rogue AP 250. CWC 240 may connect to the unsecured wireless network associated with rogue AP 250.

In one embodiment, CWC 240 transmits a marked network communication to rogue AP 250. The network communication may be a packet, such as a user datagram protocol (UDP) packet, marked with a pre-determined IP address placed in a destination field of a header of the packet. The IP address is designated for the purpose of defecting rogue wireless access points (rogue APs) by identifying that the packet was sent from a rogue AP and/or for indicating a path of the packet includes a rogue access point (AP). The packet may be also marked with a source port, such as a source UDP port, designated for the same purpose. The marked packet is received by rogue AP 250 and is forwarded through normal forwarding procedures to network switch 211.

The marked packet is received at port 3 of network switch 211. Using the marked packet, network switch 211 detects that the marked packet was sent by a rogue AP. Packets typically remain on a normal forwarding path within network devices. In some situations, packets may be tagged for exceptions and thereby removed from the normal forwarding path within the network device. For example, network switch 211 may be configured to filter out packets having a destination address that matches the designated IP address and/or having a source UDP port matching the designated source UDP port. As such, the marked packet, which is marked with the designated IP address in the destination field, may be filtered out and sent to a rogue detection module of network switch 211 for further processing. The rogue detection module may verify that the marked packet includes the designated IP address in the destination field and/or includes the designated source UDP port.

Network switch 211 determines a location that connects rogue AP 250 to controlled wired network 215. In one embodiment, network switch 211 determines the port from which the marked packet was received, i.e., port 3. An address of rogue AP 250 may also be determined. For example, a Media Access Control (MAC) address of rogue AP 250 may be extracted from the marked packet.

Rogue AP 250 may be quarantined from controlled wired network 215. In one embodiment, network switch 211 applies an access control list (ACL) to block packets coming from an address of rogue AP 250. In another embodiment, the port of a network switch that maps to the address of the rogue AP may be disabled. For example, the address of rogue AP 250 maps to port 3, which may be disabled by network switch 211, thereby blocking the marked packet and future packets from rogue AP 250. As such, rogue APs may be detected and disabled quickly and without intervention, for example by a network administrator.

In another embodiment, controlled AP 232 may identify rogue AP 250 as being a rogue AP, connect to the unsecured wireless network associated with rogue AP 250, and transmit a marked network communication via the connection.

Marking Network Communications

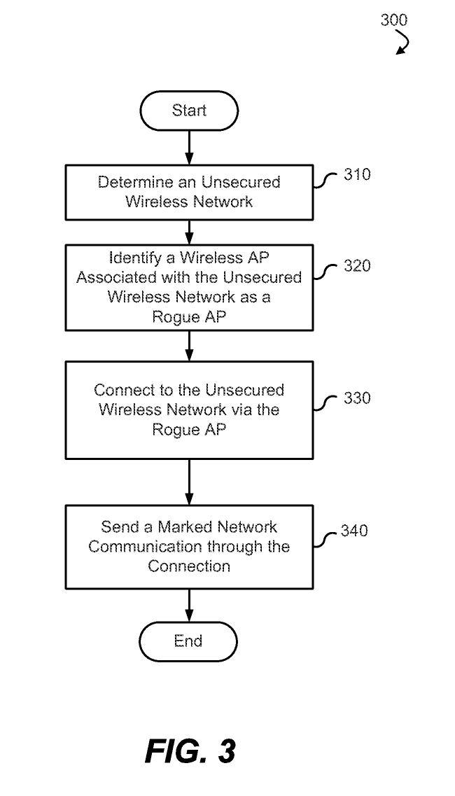

FIG. 3 is a process flow diagram for sending a marked network communication in accordance with an embodiment of the invention. The depicted process flow 300 is carried out by execution of one or more sequences of executable instructions. In another embodiment, the process flow 300 is carried out by execution by components of a network node, an arrangement of hardware logic, e.g., an Application-Specific Integrated Circuit (ASIC), etc.

In a network having one or more controlled devices, such as controlled APs or controlled wireless clients (CWC), and a rogue wireless access point (rogue AP), the rogue AP may be identified and a marked network communication may be sent. The network communication may be marked to enable rogue APs to be detected and/or to flag that the network communication is being sent through a rogue AP. As used herein, the controlled device may include a controlled AP, a controlled wireless client (CWC), or other device of the network under the purview of a common security policy and/or common management. The network may be a wireless local area network (WLAN) which conforms to the IEEE 802.11 standard.

At step 310, an unsecured wireless network may be determined. In one embodiment, a scan may be performed for unsecured networks within radio range to a physical location. For example, an AP in the network may transmit a beacon that announces the AP's presence to potential wireless clients. The beacon may carry with it information as to whether the wireless network is secured or unsecured. Upon performing the scan, one or more beacons may be detected. In another example, a probe may be sent requesting any AP within radio range to respond and provide information as to whether the wireless networks associated therewith are secured or unsecured.

In one embodiment, a controlled device may be configured to search for unsecured wireless networks upon request, for example from a network manager. In another embodiment, the controlled device may be configured to search for unsecured wireless networks on a periodic basis, independent of the network manager. For example, a search may be tied to a timer (e.g., screen saver timer, etc.) such that searching is performed every x minutes. A combination of periodic searching and request-based searching may be performed.

At step 320, a wireless AP associated with the unsecured wireless network is identified as a rogue AP. Typically, wireless networks are named at setup, for example as a service set identifier (SSID). A name of the unsecured wireless network found at step 310 may be checked against a list of known valid networks. The valid networks may be under the purview of the common security policy and/or common management. In one embodiment, where the name of the unsecured wireless network is not on the list, the wireless AP is deemed to be a rogue AP.

In one embodiment, steps 310 and 320 may be combined such that a wireless AP associated with a found wireless network is identified as a rogue AP if the found wireless network is unsecured and does not have a name that is validated.

A connection is established to the unsecured wireless network via the rogue AP, at step 330. The default configurations of many wireless APs allow any client to connect thereto. These wireless APs typically assign the client an IP address via dynamic host configuration protocol (DHCP). In one embodiment, the controlled device may connect to the unsecured wireless network. For example, a controlled AP may connect to the unsecured wireless network in bridge mode, becoming a client of the rogue AP.

At step 340, a marked network communication is sent through the connection. For example, a packet is generated and transmitted to the rogue AP. The packet may be any type of packet, such as a user datagram protocol (UDP) packet, that is re-forwarded by an AP and that includes a designated marker that would not normally be expected in the network. For example, the packet may be a type of IP packet. The features as described herein may also be used in the context of non-IP packets.

To facilitate detection of rogue APs and identification of the packet as one which was sent through a rogue AP, the packet may be generated to include the designated marker. In one embodiment, the destination address in the packet header may be marked with a valid address designated for this purpose. In one embodiment, the designated address is an IP address used only for detecting rogue APs and is not assigned to any device in the network. The designated address is valid within the network. By using a valid designated address, there is no violation of standard protocols, for example, by overwriting standard fields in a packet header with non-standard data.

The network communication may be also marked with additional information designated for the same purpose, i.e., detection of rogue APs. The additional information may be a source UDP port, a particular pattern used in the data portion of the packet which would make it unlikely to be mistaken for regular data, or the like. For example, a dedicated source UDP port not used by other networking protocols or applications may be marked in the header of the network communication. In addition to the designated IP address, the source UDP port may minimize the likelihood of false-positives, i.e., detecting an authorized wireless AP as a rogue. In one embodiment, the designated address and the designated source port may be predetermined, for example during setup and/or configuration.

In one embodiment, the marked network communication may be transmitted to the rogue AP via the connection to the unsecured wireless network.

Detection and Quarantine of a Rogue Wireless Access Point

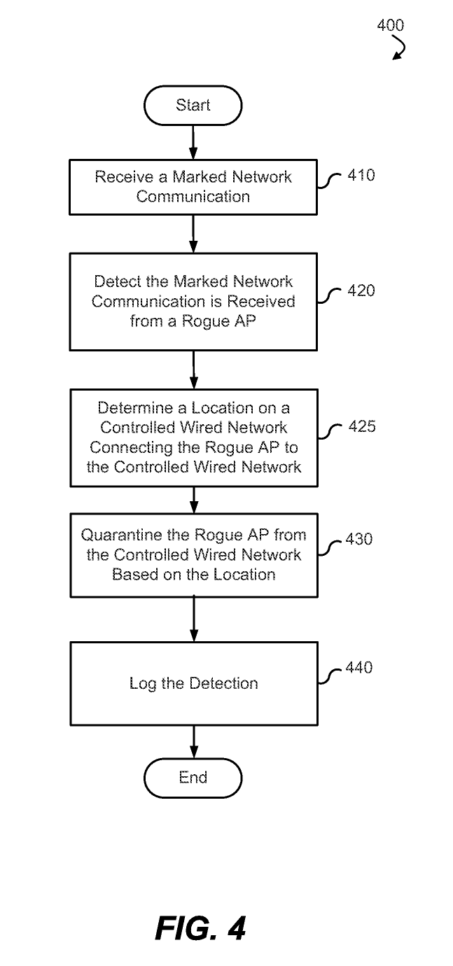

FIG. 4 is a process flow diagram for detecting a rogue wireless access point in accordance with an embodiment of the invention. The depicted process flow 400 is carried out by execution of one or more sequences of executable instructions. In another embodiment, the process flow 400 is carried out by execution by components of a network node, an arrangement of hardware logic, e.g., an Application-Specific Integrated Circuit (ASIC), etc.

At step 410, a marked network communication is received, for example, from a client device. The marked network communication may be a packet that has a value in a field that is designated for the purpose of detecting rogue wireless access points (rogue APs) by identifying that the packet was sent from a rogue AP and/or for indicating a path of the packet includes a rogue access point (AP). A marker may be a designated destination address. The marker may also include additional information in the packet designated for the same purpose. In one embodiment, the marked network communication is received by an edge device, such as a switch.

The marked network communication is detected as being received from a rogue AP, at step 420. The marked network communication is recognized as coming from a rogue AP. For example, using packet filtering techniques, a filter may be established for separating out packets if a destination field of the packet matches the designated address marker. In another embodiment, the packet is filtered if the source port in the packet matches a designated source port marker. Since the marked network communication received at step 410 includes the designated address and possibly the source port, it may be separated out after filtering.

At step 425, a location on a controlled wired network that connects the rogue AP to the controlled wired network is determined upon filtering. In one embodiment, an edge port through which the marked network communication was received is determined, for example, by the edge device connected to the rogue. An address of the rogue AP may also be determined. For example, a Media Access Control (MAC) address of the rogue AP may be extracted from the marked packet. As such, the rogue AP is defected, and the location of connection to the controlled wired and the address of the rogue AP are determined.

At step 430, the rogue AP is quarantined from the controlled wired network based on the location. Since the port from which the marked network communication was received and the address of the rogue AP is known, the rogue AP may be quarantined using this information. For example, an access control list (ACL) may be applied to block packets coming from the address associated with the rogue AP. In one embodiment, the MAC address of the rogue AP may be blocked at the edge network device. In another embodiment, the edge port and/or the edge network device connected to the rogue AP may be disabled. Other known methods of establishing a quarantine process may also be applied.

At step 440, the detection that the network communication was received from the rogue AP may be logged. For example, an internal log may be updated to reflect the location that connects the rogue AP to the controlled wired network, MAC address of the rogue AP, etc. As such, the location where the rogue AP is connected to the controlled wired network may be determined with precision and speed. A management station, such as a network manager, may be notified of the detection via simple network management protocol (SNMP) or other network management protocol.

A network manager may use the information captured, for example, by the edge device to determine the edge port connecting the rogue AP to the controlled wired network, Further actions may be taken, for example, by the network manager or network administrative entities that may prevent future security threats.

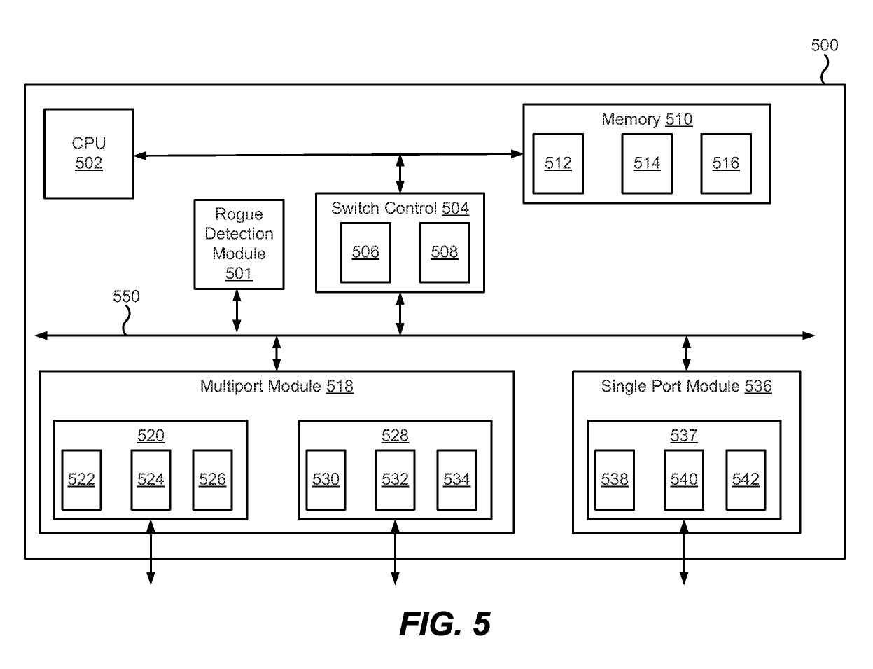

FIG. 5 is a block diagram of an exemplary packet switch in accordance with an embodiment of the invention. The specific configuration of packet switches used may vary depending on the specific implementation. A central processing unit (CPU) 502 performs overall configuration and control of the switch 500 in operation. The CPU 502 operates in cooperation with switch control 504, an application specific integrated circuit (ASIC) designed to assist CPU 502 in performing packet switching at high speeds.

The switch control 504 controls the “forwarding” of received packets to appropriate locations within the switch for further processing and/or for transmission out another switch port. Inbound and outbound high speed FIFOs (506 and 508, respectfully) are included with the switch control 504 for exchanging data over switch bus 550 with port modules. In accordance with an embodiment of the invention, the switch control 504 is an ASIC and is configured to filter out packets having a destination address that matches the designated address and/or having a source port that matches the designated source port.

Rogue detection module 501 is configured to detect a rogue AP using information contained in a marked network communication. In one embodiment, rogue detection module 501 is configured to verify that marked network communications which have been filtered include a designated IP address in the destination field and/or include a designated source port. Rogue detection module 501 is further configured to determine an edge port from which the packet was received, determine an address of a client device associated with the edge port, and quarantine a rogue AP, for example by adding an address of the rogue AP to an access control list (ACL) and filtering packets according to the ACL. In another embodiment, rogue detection module 501 is configured to disable a port of switch 500 connected to the rogue AP.

Memory 510 includes a high and low priority inbound queue (512 and 514, respectively) and outbound queue 518. High priority inbound queue 512 is used to hold received switch control packets awaiting processing by CPU 502 while low priority inbound queue 514 holds other packets awaiting processing by CPU 502. Outbound queue 518 holds packets awaiting transmission to switch bus 550 via switch control 504 through its outbound FIFO 508. CPU 502, switch control 504 and memory 510 exchange information over processor bus 552 largely independent of activity on switch bus 550.

The ports of the switch may be embodied as plug-in modules that connect to switch bus 550. Each such module may be, for example, a multi-port module 518 having a plurality of ports in a single module or may be a single port module 536. A multi-port module provides an aggregate packet switch performance capable of handling a number of slower individual ports. For example, in one embodiment, both the single port module 536 and the multi-port module 518 may be configured to provide, for example, approximately 1 Gbit per second packet switching performance. The single port module 538 therefore can process packet switching on a single port at speeds up to 1 Gbit per second. The multi-port module 518 provides similar aggregate performance but distributes the bandwidth over, preferably, eight ports each operating at speeds, for example, of up to 100 Mbit per second. These aggregated or trunked ports may be seen as a single logical port to the switch.

Each port includes high speed FIFOs for exchanging data over its respective port. Specifically, each port, 520, 528, and 537, preferably includes an inbound FIFO 522, 530, and 538, respectively for receiving packets from the network medium connected to the port. Further, each port 520, 528, and 537, preferably includes a high priority outbound FIFO 524, 532, and 540, respectively, and a low priority outbound FIFO 526, 534, and 542, respectively. The low priority outbound FIFOs are used to queue data associated with transmission of normal packets while the high priority outbound FIFO is used to queue data associated with transmission of control packets. Each module (518 and 536) includes circuits (not specifically shown) to connect its port FIFOs to the switch bus 550.

As packets are received from a port, the packet data is applied to the switch bus 550 in such a manner as to permit monitoring of the packet data by switch control 504. In general, switch control 504 manages access to switch bus 550 by all port modules (i.e., 518 and 538). All port modules “listen” to packets as they are received and applied by a receiving port module to switch bus 550. If the packet is to be forwarded to another port, switch control 504 applies a trailer message to switch bus 550 following the end of the packet to identify which port should accept the received packet for forwarding to its associated network link.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage medium that are suitable for storing a program or programs that, when executed, for example by a processor, implement embodiments of the present invention. Accordingly, embodiments provide a program comprising code for implementing a system or method as claimed in any preceding claim and a machine readable storage medium storing such a program. Still further, embodiments of the present invention may be conveyed electronically via any medium such as a communication signal carried over a wired or wireless connection and embodiments suitably encompass the same.

All of the features disclosed In this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

What is claimed is:

1. A method of processing a packet, the method comprising:
receiving the packet by a network device of a wired network;
filtering the packet if a field in the packet matches a marker designated for indicating a path of the packet includes a rogue access point (AP); and
upon filtering, determining a location on the wired network connecting the wired network to a rogue AP from which the packet was received.

2. The method of claim 1, wherein determining further comprises:
determining an edge port of the network device through which the packet was received.

3. The method of claim 1, further comprising:
determining an address of the rogue AP from which the packet was received.

4. The method of claim 3, further comprising:
blocking the address of the rogue AP at the network device.

5. The method of claim 3, further comprising:
logging at least one of the location and the address of the rogue AP.

6. The method of claim 1, wherein the packet is filtered if an address field in the packet matches a network address marker designated for indicating the path of the packet includes the rogue AP.

7. The method of claim 1, wherein the packet is a user datagram protocol (UDP) packet.

8. The method of claim 7, further comprising:
filtering the packet if the source UDP port field in the packet matches a designated source UDP port marker.

9. An edge network device for use in a wired network, the wired network including a plurality of network nodes, the edge network device comprising:
an edge port configured to receive a packet;
a switch controller coupled to the edge port, wherein the switch controller is configured to filter the packet if a destination address field in the packet matches a network address designated for indicating a path of the packet includes a rogue access point (AP); and
a rogue detection module coupled to the switch controller, wherein the rogue detection module is configured to:
determine the edge port from which the packet was received; and
determine an address of a client device from which the packet was received.

10. The device of claim 9, wherein the rogue detection module is further configured to block the address of the client device at the edge network device.

11. A method comprising:
determining an unsecured wireless network by a controlled node of a wireless network system;
identifying a wireless access point (AP) associated with the unsecured wireless network as a rogue AP;
connecting to the unsecured wireless network through the rogue AP; and
transmitting to the rogue AP a packet including a marker designated for indicating a path of the packet includes the rogue AP.

12. The method of claim 11, wherein the wireless network system includes at least one controlled network device connected to a wired network, and wherein the marker is a valid address in the wired network and is unassigned in the wired network.

13. The method of claim 11, wherein the marker is an IP address placed in a destination field of a header of the packet.

14. The method of claim 11, wherein the marker further includes a source UDP port designated for indicating the path of the packet includes the rogue AP.

15. The method of claim 11, wherein the packet is a user datagram protocol (UDP) packet.
